(19) United States
(12) Patent Application Publication
(10) Pub. No.: US 2026/0043825 A1
(43) Pub. Date: Feb. 12, 2026

(54) SENSOR-ATTACHED CABLE

(71) Applicant: Proterial, Ltd., Tokyo (JP)

(72) Inventors: Hiroshi YAMADA, Tokyo (JP); Teruyoshi SHIROTA, Tokyo (JP)

(73) Assignee: Proterial, Ltd., Tokyo (JP)

(21) Appl. No.: 19/282,469

(22) Filed: Jul. 28, 2025

(30) Foreign Application Priority Data
Aug. 8, 2024 (JP) 2024-131997

(51) Int. Cl. G01P 3/48; H01R 4/18

(52) U.S. Cl. CPC G01P 3/48; H01R 4/184

(57) ABSTRACT

A sensor-attached cable includes a sensor with a connection terminal, a cable, a crimp terminal provided at an end of the cable and connected to the connection terminal, and a holder that holds the sensor and the crimp terminal, wherein the crimp terminal has a cylindrical mating portion that mates with the connection terminal, wherein the mating portion has a slit formed along its axial direction and is configured to be elastically deformable so that the slit can open and close, wherein the holder has a groove to accommodate the crimp terminal, wherein at least either of the mating portion or the groove has a retaining portion which prevents the mating portion from slipping out of the groove when the mating portion is accommodated in the groove, and which presses the mating portion in a direction that the slit closes.

### CROSS-REFERENCE TO RELATED APPLICATIONS

The present patent application claims the priority of Japanese patent application No. 2024-131997 filed on Aug. 8, 2024, and the entire contents thereof are hereby incorporated by reference.

### TECHNICAL FIELD

This invention relates to a sensor-attached cable (i.e., cable with sensor).

### BACKGROUND TECHNOLOGY

Conventionally, sensor-attached cables, in which a sensor is provided at the end of the cable, are well known (see Patent Literatures 1 and 2 as examples). In some sensor-attached cables, a resin mold portion is provided to cover the cable end and the sensor.

### CITATION LIST

### Patent Literatures

Patent Literature 1: JP 2005-227095A
Patent Literature 2: JP 1998-319037

### SUMMARY OF THE INVENTION

In the above conventional sensor-attached cables, a connection part between the sensor and the cable was sometimes damaged by molten resin that flows in during the molding of the resin mold portion.

Therefore, the object of this invention is to provide a sensor-attached cable that can hold a connection part between a sensor and a cable more firmly.

### Measure to Solve the Problem

To solve the above problem, one aspect of the present invention provides a sensor-attached cable, comprising:
a sensor with a connection terminal;
a cable;
a crimp terminal provided at an end of the cable and connected to the connection terminal; and
a holder that holds the sensor and the crimp terminal;
wherein the crimp terminal has a cylindrical mating portion that mates with the connection terminal,
wherein the mating portion has a slit formed along its axial direction and is configured to be elastically deformable so that the slit can open and close,
wherein the holder has a groove to accommodate the crimp terminal,
wherein at least either of the mating portion or the groove has a retaining portion which prevents the mating portion from slipping out of the groove when the mating portion is accommodated in the groove, and which presses the mating portion in a direction that the slit closes.

### Advantageous Effects of the Invention

According to the present invention, it is possible to provide a sensor-attached cable that can hold a connection part between a sensor and a cable more firmly.

### BRIEF DESCRIPTION OF THE DRAWINGS

FIG. 1 is a perspective view showing a schematic configuration of a rotation detection device using a sensor-attached cable according to an embodiment of the present invention.

FIGS. 2A and 2B are diagrams showing an internal structure of the sensor-attached cable, wherein FIG. 2A is a plan view and FIG. 2B is a cross-sectional view taken along the line A-A of FIG. 2A.

FIGS. 3A, 3B, and 3C are diagrams showing a crimp terminal, wherein FIG. 3A is a plan view, FIG. 3B is a side view, and FIG. 3C is a cross-sectional view taken along the line B-B of FIG. 3B.

FIGS. 4A and 4B are explanatory diagrams illustrating the connection between a magnetic sensor 4 and a crimp terminal 5.

FIGS. 5A and 5B are explanatory diagrams illustrating the insertion of the crimp terminals into the groove.

FIGS. 6A to 6C are diagrams showing modified examples of a return (i.e., pushback) portion.

FIG. 7 is a diagram showing a modified example of the retaining portion.

### DETAILED DESCRIPTION OF THE EMBODIMENT

### Embodiment

An embodiment according to the present invention will be described below with reference to the accompanying drawings.

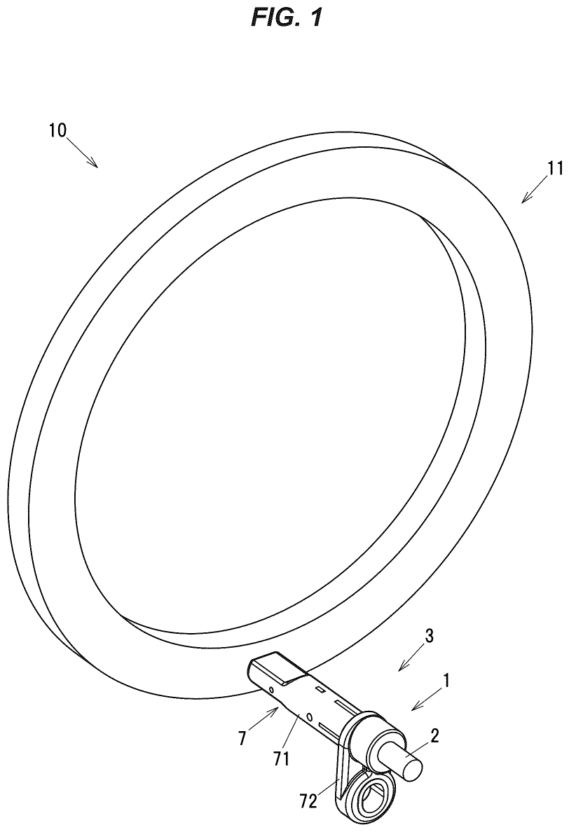

FIG. 1 is a perspective view showing a schematic configuration of a rotation detection device 10 using a sensor-attached cable 1 according to an embodiment of the present invention. As shown in FIG. 1, the rotation detection device 10 has the sensor-attached cable 1 according to the present embodiment and a detection target (i.e., a member to be detected) 11. The rotation detection device 10 is used, for example, to detect the rotation speed of a wheel, i.e., wheel speed, of an automobile.

The detection target 11 is attached to a rotating member (not shown) and rotates with it. When the rotation detection device 10 is used to detect the wheel speed, the rotating member is, for example, an inner ring that is attached to the wheel and rotates with the wheel. The detection target 11 is formed in the shape of a circular ring (i.e., an annular shape) and a plate perpendicular to the rotation axis of the rotating member, and is attached, for example, to the outer circumference of the rotating member.

In the present embodiment, the detection target 11 is composed of a magnetic encoder with a plurality of magnetic poles along the circumferential direction centered on the rotation axis of the rotating member. The detection target 11 has north magnetic poles and south magnetic poles arranged alternately along the circumferential direction.

### (Sensor-Attached Cable 1)

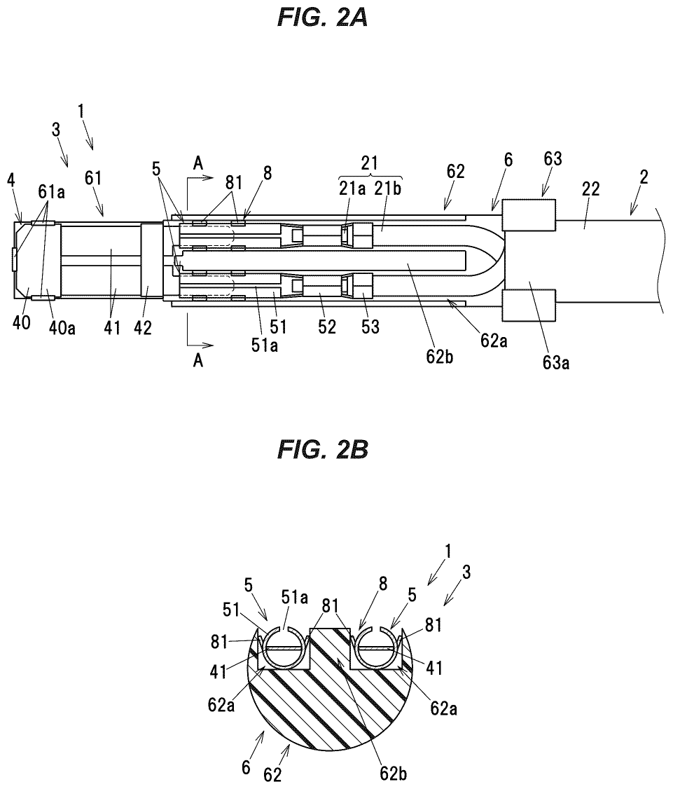

FIGS. 2A and 2B are diagrams showing an internal structure of the sensor-attached cable 1. FIG. 2A is a plan view and FIG. 2B is a cross-sectional view taken along the line A-A of FIG. 2A. As shown in FIGS. 2A and 2B, the sensor-attached cable 1 has a cable 2 and a sensor unit 3 provided at the end of the cable 2.

### (Cable 2)

The cable 2 has a pair of wires 21 corresponding to a pair of connection terminals 41 of the magnetic sensor 4 described below. Each of the wires 21 has a conductor 21a, which is a stranded conductor configured of high conductive strands made of copper or the like twisted together, and an insulator 21b, which is coating around the outer circumference of the conductor 21a and made of an insulating resin such as cross-linked polyethylene. The cable 2 further has a sheath 22 that collectively covers the pair of wires 21. At the end of the cable 2, the pair of wires 21 is exposed from the sheath 22, and furthermore, at the end of the respective wire 21, the conductor 21a is exposed from the insulator 21b.

### (Sensor Unit 3)

The sensor unit 3 is installed at the end of the cable 2. The sensor unit 3 is attached to a fixed member that does not rotate with the rotation of the rotating member. For example, when the rotation detection device 10 is used to detect the wheel speed, the fixed member is, for example, a knuckle that is connected to the car body and supports the outer wheel. The sensor unit 3 is positioned opposite the detection target 11 (see FIG. 1). The sensor unit 3 has the magnetic sensor 4, the crimp terminal 5, a holder 6, and a resin mold portion 7. Each part will be described in detail below.

### (Magnetic Sensor 4)

The sensor unit 3 has a magnetic sensor 4 as a sensor of the present invention. The magnetic sensor 4 has a plate-shaped detection unit 40 including a magnetic detection element (not shown in the figure) that detects the magnetic field from the detection target 11, and the pair of connection terminals 41 extending from the detection unit 40. As the magnetic detection element, a Hall element and an MR (magnetoresistive) element can be used. As the MR element, GMR (Giant Magneto Resistive effect) element, AMR (Anisotropic Magneto Resistive) element, Tunneling Magneto Resistive (TMR) element, and the like can be used. The detection unit 40 has the magnetic detection element, a signal processing circuit (not shown in the figure), and a resin mold 40a as a covering that collectively covers the magnetic detection element and the signal processing circuit. The pair of connection terminals 41 is formed in the form of a strip (elongated plate). The connection terminals 41 are beveled at their leading edges and tapered at the tips to facilitate insertion into the mating portion 51 which is described below. A capacitive element for noise suppression is connected between the two connection terminals 41, and a capacitive element protection portion 42 formed by molding resin is provided to cover the capacitive element and the surrounding connection terminals 41.

### (Crimp Terminal 5)

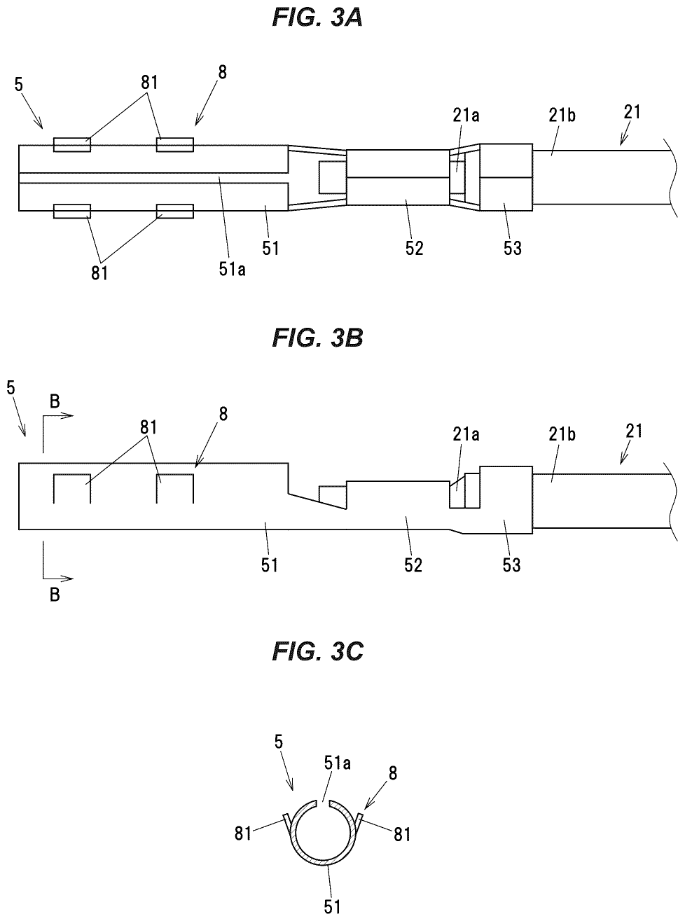

FIGS. 3A, 3B, and 3C are diagrams showing a crimp terminal.

FIG. 3A is a plan view, FIG. 3B is a side view, and FIG. 3C is a cross-sectional view taken along the line B-B of FIG. 3B. As shown in FIGS. 2 and 3, the crimp terminal 5 is provided at the end of the cable 2, and by connecting the connection terminals 41 of the magnetic sensor 4 to the crimp terminal 5, the cable 2 and the magnetic sensor 4 are electrically connected via the crimp terminal 5. In the present embodiment, the pair of crimp terminals 5 of the same shape is provided, which corresponds to the pair of connection terminals 41 respectively.

The crimp terminal 5 is made of conductive material and is formed, for example, by pressing a metal sheet. The crimp terminal 5 can be made of, for example, copper, copper alloy such as brass, aluminum, aluminum alloy, or the like. The crimp terminal 5 has a mating portion 51, a first crimp portion 52, and a second crimp portion 53 in one piece. The first crimp portion 52 is crimp-fixed (caulking fixed) to the exposed conductor 21a at the end of the wire 21. The second crimp portion 53 is crimp-fixed (caulking fixed) to the end of the insulator 21b.

The mating portion 51 is a part to which the connection terminal 41 is mated and is formed in a cylindrical shape. The mating portion 51 has a slit 51a formed along its axial direction (right and left direction in FIG. 2A) and is configured to be elastically deformable so that the slit 51a can open and close. In the present embodiment, the mating portion 51 is formed as a whole in an abbreviated cylindrical shape, and the slit 51a is formed to have an abbreviated C-shaped cross-section perpendicular to the axial direction.

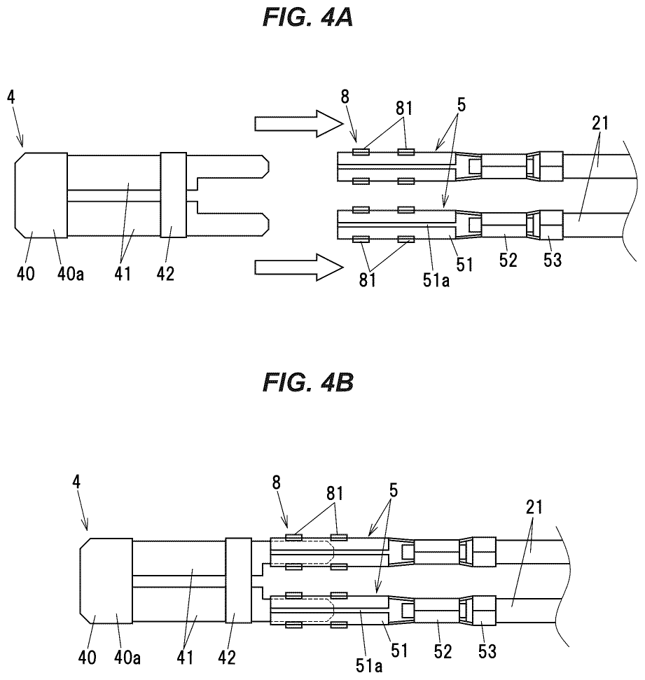

FIGS. 4A and 4B are explanatory diagrams illustrating the connection between the magnetic sensor 4 and the crimp terminal 5. The inner diameter of the mating portion 51 is slightly smaller than the width of the connection terminal 41, so that when the connection terminal 41 is inserted and mated into the mating portion 51, the end face of the connection terminal 41 in the width direction firmly contacts the inner circumference of the mating portion 51. As the connection terminal 41 is inserted into the mating portion 51, the mating portion 51 elastically deforms so that the slit 51a opens slightly. After connecting the magnetic sensor 4 and the crimp terminal 5, the connected magnetic sensor 4 and the crimp terminal 5 are set in the holder 6.

Additionally, a contact point such as a plate spring that contacts the surface or back surface of the connection terminal 41 may be provided to the mating portion 51 to increase the contact area between the crimp terminal 5 and the connection terminal 41. However, in this case, the structure of the connection terminal 41 becomes more complicated and more costly. Therefore, in the present embodiment, the contact point such as a plate spring is omitted to reduce cost, but the connection between the crimp terminal 5 and the connection terminal 41 is firmly held by holding down the mating portion 51 by a retaining portion 8 (described below). This makes it possible to maintain a stable electrical connection between the connection terminal 41 and the crimp terminal 5, even when only the end face of the connection terminal 41 in the width direction is in contact with the crimp terminal 5. Details of the retaining portion 8 will be described below.

The shape of the mating portion 51 is not limited to cylindrical. However, it is desirable that the shape of the mating portion 51 be such that it can hold the connection terminal 41 firmly and inhibit its misalignment. For example, when the mating portion 51 is made in a square cylindrical shape and configured to sandwich the connection terminal 41 in the width direction between the sides facing each other, it is desirable to manage the connection terminal 41 so that it does not shift position in the direction of its thickness. By making the mating portion 51 cylindrical as in the present embodiment, the connection terminal 41 can be firmly held and misalignment can be controlled. Furthermore, since machining can be easily performed, the manufacturing costs can be reduced.

### (Holder 6)

The holder 6 is a member to protect the connection portion between the magnetic sensor 4 and the cable 2 when forming a resin mold portion 7 described below, and is configured to hold the magnetic sensor 4, the crimp terminal 5, and an end portion of the cable 2. The holder 6 is formed in advance by injection molding or other means. Here, the holder 6 made of nylon is used. However, not limited to this, the holder 6 may be made of, for example, an insulating resin material such as PBT (polybutylene terephthalate).

The holder 6 has, in one piece, a magnetic sensor holding portion 61 that holds the magnetic sensor 4, a terminal holding portion 62 with a groove 62a that accommodates a tip of the connection terminal 41 of the magnetic sensor 4, the crimp terminal 5, and a tip of the wire 21 (an exposed portion from the sheath 22), and a sheath holding portion 63 which holds an end of the sheath 22 of the cable 2.

The magnetic sensor holding portion 61 is configured to have locking claws 61a for locking (fixing) the detection unit 40. In the configuration here, three locking claws 61a are used to lock the detection unit 40 on three sides excluding the extension side of the connection terminal 41.

The terminal holding portion 62 has a pair of grooves 62a corresponding to the pair of crimp terminals 5 respectively. Here, the pair of grooves 62a in straight shape are formed in parallel, but the shape of the grooves 62a may be changed as needed. A convex bulkhead 62b formed between the pair of grooves 62a prevents the pair of crimp terminals 5 from causing a short circuit by contacting each other. A sheath holding portion 63 is formed in an abbreviated C-shape in cross-sectional view. When having the sheath holding portion 63 hold the cable 2, the cable 2 is inserted into the sheath holding portion 63 while elastically deforming the sheath holding portion 63 so as to widen the slit portion 63a. In the present embodiment, the sheath holding portion 63 holds the end of the sheath 22 of the cable 2.

### (Resin Mold Portion 7)

Going back to FIG. 1, in the present embodiment, a resin mold portion 7 is formed by resin molding with the magnetic sensor 4, the crimp terminal 5, and the end of cable 2 set in the holder 6. The resin mold portion 7 is composed of a main body 71 that collectively covers the magnetic sensor 4, the crimp terminal 5, the end of the cable 2, and the holder 6, and a flange 72 for securing the sensor unit 3 to a fixed member, which are formed in one piece.

### (Retaining Portion 8)

In the present embodiment, the holder 6 is configured to hold the detection unit 40 of the magnetic sensor 4 and the sheath 22 of the cable 2, but the crimp terminal 5, which is located between them, could float away from the holder 6 due to the molten resin flow when the resin mold portion 7 is molded, which could result in defects such as poor contact and wire breakage. Therefore, in the sensor-attached cable 1 according to the present embodiment, a retaining portion (i.e., stopper portion) 8 is formed in the mating portion 51 of the crimp terminal 5 to prevent the mating portion 51 from slipping out of the groove 62a when the mating portion 51 is accommodated in the groove 62a.

In the present embodiment, the retaining portion 8 comprises one or more pairs of tongue-shaped return (pushback) portions 81 formed in the mating portion 51. Each pair of return portions 81 is formed so as to face each other across the slit 51a, and extends diagonally (diagonally toward the upper right and upper left in FIG. 3A) outward in the facing direction (left-right direction in FIG. 3C) and toward the slit side in the facing direction and perpendicular to the axial direction (upper side in FIG. 3C). The return portions 81 are formed, for example, by punching out a portion of the metal plate that will become the mating portion 51 by a press process or the like to form tongue-shaped portions, bending the portion other than the tongue-shaped portion into a cylindrical shape, and projecting the unbent tongue-shaped portion outwardly. Also, the return portions 81 may be formed by bending the tongue-shaped portion outwardly. It is desirable that the paired return portions 81 be symmetrically formed with respect to a plane passing through the center of the slit 51a and the center of the mating portion 51.

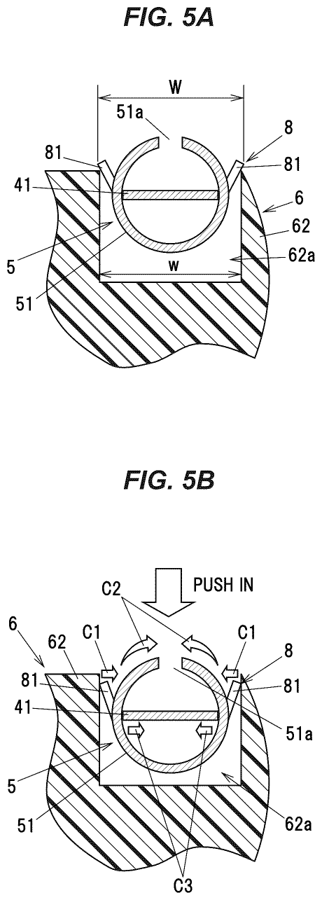

As shown in FIG. 5A, the crimp terminal 5 is fitted into the groove 62a with the slit 51a facing upwards. When no load is applied to the return portions 81, a distance W between the ends of the pair of return portions 81 is made larger than a width w of the groove 62a. Therefore, as shown in FIG. 5B, when the crimp terminal 5 is pushed into the groove 62a, the return portions 81 are pressed inward (inward here means opposite the returning direction of the return portions 81) (arrows C1 in the figure), and the return portions 81 bite into the inner wall of the groove 62a to prevent the crimp terminal 5 from coming off. Also, since the return portions 81 are pressed inward, the mating portion 51 is pressed in the direction where the slit 51a closes (arrows C2). Thus, the inner surface of the mating portion 51 is pressed more firmly against the end face of the connection terminal 41 (arrows C3), resulting in a stronger connection between the magnetic sensor 4 and the crimp terminal 5.

To make the connection of the connection terminal 41 stronger, it is desirable that at least a pair of the return portions 81 be formed facing each other at the positions where the connection terminal 41 is sandwiched between them, when the connection terminal 41 is mated with the mating portion 51. In other words, it is desirable that the axial positions of the pair of return portions 81 be formed at the positions where they radially overlap with the connection terminal 41 when the connection terminal 41 is mated with the mating portion 51. To further enhance the effect of retaining, it is desirable that a plurality of pairs of the return portions 81 be formed in the mating portion 51, spaced apart in the axial direction. In a case described here, two pairs of return portions 81 are formed, with one pair of return portions 81 formed in axial positions that overlap the connection terminal 41 and the other pair of return portions 81 formed in axial positions that hardly overlap the connection terminal 41 (overlapping only the beveled portion at the tip of the connection terminal 41).

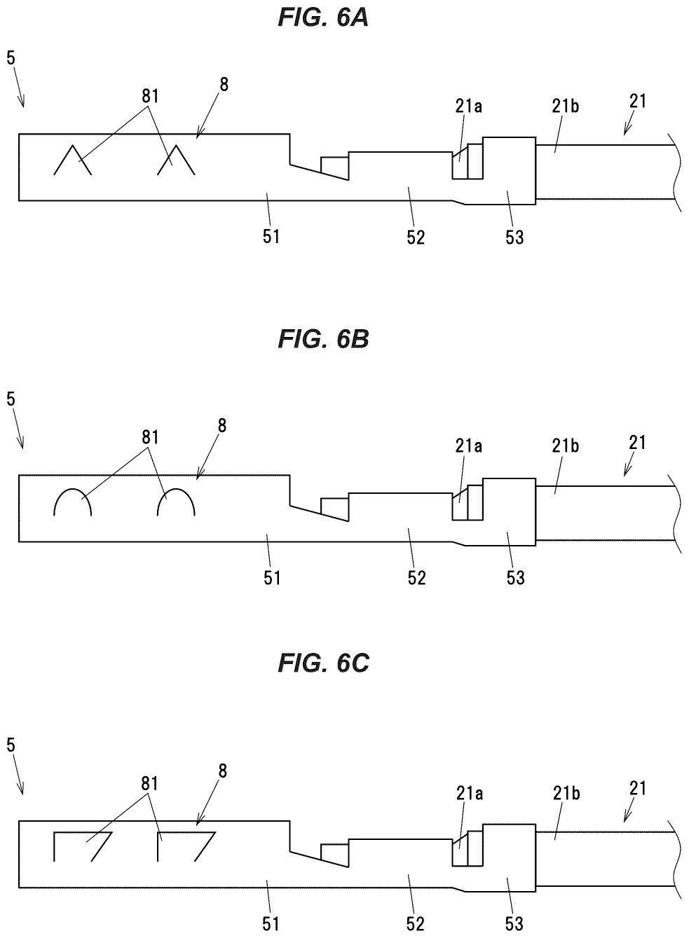

Here, the shape of the return portions 81 is rectangular in side view (see FIG. 3B), but the shape of the return portions 81 is not limited to this. For example, the shape of the return portions 81 in the side view may be triangular as shown in FIG. 6A or semicircular as shown in FIG. 6B to further enhance the effect of retaining. In addition, as shown in FIG. 6C, by making the shape of the return portions 81 pointed on the extending side of the wire 21, misalignment of the connection terminal 41 due to pulling can be suppressed, even when a force in the direction of pulling the cable 2 is applied.

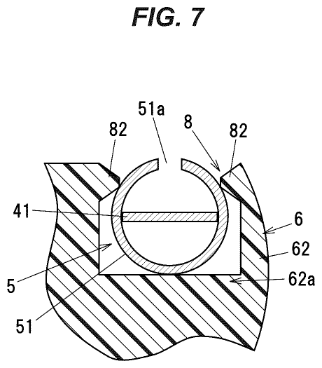

In the present embodiment, the case of forming the retaining portion 8 on the crimp terminal 5 side is described, but the retaining portion 8 may be formed on the holder 6 side, i.e., on the inner wall of the groove 62a. For example, as shown in FIG. 7, a pair or more of protrusions 82 protruding inwardly may be provided on the inner wall of the groove 62a, so that the protrusions 82 stop the mating portion 51 from slipping out of the groove 62a and hold the mating portion 51 in the direction where the slit 51a is closed. The retaining portion 8 may be formed on both the mating portion 51 and the groove 62a. In this manner, the retaining portion 8 may be formed on at least either of the mating portion 51 or the groove 62a.

### Functions and Effects of the Embodiment

As explained above, in the sensor-attached cable 1 according to the present embodiment, at least either of the mating portion 51 of the crimp terminal 5 or the groove 62a of the holder 6 has a retaining portion 8 that prevents the mating portion 51 from slipping out of the groove 62a when the mating portion 51 is accommodated in the groove 62a, and at the same time, holds the mating portion 51 in the direction where the slit 51a is closed.

Having the retaining portion 8 prevents the crimp terminal 5 from being lifted off the holder 6 by the molten resin when the resin mold portion 7 is formed, and at the same time, enables more stable connection between the crimp terminal 5 and the connection terminal 41. In other words, according to the present embodiment, the connection between the magnetic sensor 4 and the cable 2 can be held more firmly, and the electrical connection between the two can be maintained stably.

### MODIFIED EXAMPLES

The above embodiment describes a case in which the magnetic sensor 4 and the crimp terminal 5 are connected first and then the both are fitted into the holder 6 together, but the steps are not limited to these. For example, first, the magnetic sensor 4 may be fitted into the holder 6 by itself, next, the crimp terminal 5 may be inserted while sliding along the groove 62a, and then the connection terminal 41 may be mated with the crimp terminal 5. However, it is recommendable that the rigidity of the exposed portion of the wire 21 be increased to facilitate insertion into the groove 62a, especially when the production of the sensor-attached cable 1 is automated. One way to increase rigidity is, for example, to increase a diameter of the strands that configure the conductor 21a or to increase a number of the strands. Thus, it is more desirable to connect the magnetic sensor 4 and the crimp terminal 5 first, and then fit them into the holder 6 from above (from the opening opposite the bottom of groove 62a), especially when the production of the sensor-attached cable 1 is automated.

### Summary of Embodiment

Next, technical ideas understood from the above embodiment, will be described with reference to the reference numerals and the like used in the embodiment. However, each reference numeral in the following description does not limit the constituent elements in the scope of claims to the members and the like specifically shown in the embodiments.

According to the first feature, a sensor-attached cable 1 includes a sensor magnetic sensor 4 having a connection terminal 41, a cable 2, a crimp terminal 5 provided at an end of the cable 2 and to be connected to the connection terminal 41, and a holder 6 holding the sensor magnetic sensor 4 and the crimp terminal 5, wherein the crimp terminal 5 has a cylindrical mating portion 51 that mates with the connection terminal 41, wherein the mating portion 51 has a slit 51a formed along its axial direction and is configured to be elastically deformable so that the slit 51a can be opened and closed, wherein the holder 6 has a groove 62a to accommodate the crimp terminal 5, and wherein at least either of the mating portion 51 or the groove 62a has a retaining portion 8 that prevents the mating portion 51 from being pulled out from the groove 62a when the mating portion 51 is accommodated in the groove 62a, and which presses the mating portion 51 in the direction that the slit 51a is closed.

According to the second feature, in the sensor-attached cable 1 as described by the first feature, the retaining portion 8 includes one or more pairs of tongue-shaped return portions 81 formed in the mating portion 51, and wherein the return portions 81 are formed so as to face each other across the slit 51a and extend outward in the facing direction and obliquely toward the slit in the facing direction and the direction perpendicular to the axial direction.

According to the third feature, in the sensor-attached cable 1 as described by the second feature, at least one pair of the return portions 81 is formed in positions facing each other across the connection terminal 41 when the connection terminal 41 is mated with the mating portion 51.

According to the fourth feature, in the sensor-attached cable 1 as described by the second feature, the sensor magnetic sensor 4 has a pair of the connection terminals 41, and a pair of the crimp terminals 5 corresponding to the pair of connection terminals 41 respectively, and wherein the holder 6 has a pair of the grooves 62a corresponding to the pair of the crimp terminals 5 respectively.

According to the fifth feature, in the sensor-attached cable 1, as described by the first feature, the connection terminal 41 is formed in a plate shape, wherein the mating portion 51 of the crimp terminal 5 is formed in a cylindrical shape, and wherein an end face of the connection terminal 41 in the width direction contacts the inner circumference of the mating portion 51 when the connection terminal 41 is mated with the mating portion 51.

### NOTE

The above description of the embodiments of the present invention does not limit the invention as claimed above. It should also be noted that not all of the combinations of features described in the embodiments are essential to the means for solving the problems of the invention. In addition, the invention can be implemented with appropriate modifications to the extent that it does not depart from the intent of the invention.

1. A sensor-attached cable, comprising:
a sensor with a connection terminal;
a cable;
a crimp terminal provided at an end of the cable and connected to the connection terminal; and
a holder that holds the sensor and the crimp terminal;
wherein the crimp terminal has a cylindrical mating portion that mates with the connection terminal,
wherein the mating portion has a slit formed along its axial direction and is configured to be elastically deformable so that the slit can open and close,
wherein the holder has a groove to accommodate the crimp terminal,
wherein at least either of the mating portion or the groove has a retaining portion which prevents the mating portion from slipping out of the groove when the mating portion is accommodated in the groove, and which presses the mating portion in a direction that the slit closes.

2. The sensor-attached cable according to claim 1,
wherein the retaining portion includes one or more pairs of tongue-shaped return portions formed in the mating portion,
wherein the return portions are formed so as to face each other across the slit, and extend outward in a facing direction and obliquely toward the slit in the facing direction and a direction perpendicular to the axial direction.

3. The sensor-attached cable according to claim 2, wherein at least one pair of the return portions are formed so as to face each other across the connection terminal when the connection terminal is mated with the mating portion.

4. The sensor-attached cable according to claim 2, wherein the sensor has a pair of connection terminals,
wherein a pair of crimp terminals corresponding to the pair of connection terminals respectively is provided, and
wherein the holder has a pair of grooves corresponding to the pair of crimp terminals respectively.

5. The sensor-attached cable according to claim 1,
wherein the connection terminal is formed in a plate shape,
wherein the mating portion of the crimp terminal is cylindrical,
wherein an end face of the connection terminal in a width direction is configured to contact an inner circumference of the mating portion, when the connection terminal is mated with the mating portion.
